(19) United States
(12) Patent Application Publication
(10) Pub. No.: US 2022/0379224 A1
(43) Pub. Date: Dec. 1, 2022

(54) CHESS SELF-LEARNING METHOD AND DEVICE BASED ON MACHINE LEARNING

(71) Applicant: NANJING UNIVERSITY OF POSTS AND TELECOMMUNICATIONS, Nanjing (CN)

(72) Inventors: Dengyin ZHANG, Nanjing (CN); Cheng ZHOU, Nanjing (CN)

(73) Assignee: NANJING UNIVERSITY OF POSTS AND TELECOMMUNICATIONS, Nanjing (CN)

(21) Appl. No.: 17/846,062

(22) Filed: Jun. 22, 2022

Related U.S. Application Data
(63) Continuation of application No. PCT/CN2022/094475, filed on May 23, 2022.

(30) Foreign Application Priority Data
May 28, 2021 (CN) 202110591851.8

(51) Int. Cl. A63F 13/67; A63F 13/822; G06N 3/08; A63F 3/02

(52) U.S. Cl. CPC A63F 13/67; A63F 13/822; G06N 3/08; A63F 3/02

(57) ABSTRACT

The present disclosure discloses a chess self-learning method and device based on machine learning, a move selection output layer and a value evaluation output layer of the method share the same input layer and hidden layer of a neural network, and a Monte Carlo tree search tree is used to construct a strategy optimizer. The training process of the method is divided into two parts, namely data generation and neural network training, so that an error between a value scalar outputted by a neural network and a final result of self-play is as small as possible, and a move vector outputted by the neural network is as close as possible to a decision vector given by a Monte Carlo tree for each search step. The present disclosure aims to construct an Al chess player for people to play chess.

### CROSS-REFERENCE TO RELATED APPLICATIONS

The application claims priority to Chinese patent application No. 202110591851.8, filed on May 28, 2021, the entire contents of which are incorporated herein by reference.

### TECHNICAL FIELD

The present disclosure relates to a chess self-learning method and device based on machine learning, belonging to the field of deep reinforcement learning.

### BACKGROUND

In recent years, with the development of artificial intelligence, deep reinforcement learning is more and more widely used in different fields of our lives, such as mechanized control, automatic driving and so on. Artificial intelligence has always had two development directions. One of the directions is to enable machines to learn and imitate human behavior, which requires a large amount of data on human behavior for the study of artificial intelligence. This training method of artificial intelligence is referred to as supervised learning. The other direction is to provide machines with the most basic rules, so that machines can complete the training of artificial intelligence through self-learning. This training method of artificial intelligence is referred to unsupervised learning. Compared with unsupervised learning, supervised learning has the following disadvantages. 1. The final training level depends heavily on the provided data set, which in a sense is the upper limit of the final training result. 2. A lot of data is needed for training, and it is difficult to obtain these data at most time. Unsupervised learning can overcome the shortcomings of supervised learning. Unsupervised learning accomplishes training through self-learning without any human data or experience. It is also because unsupervised learning does not depend on human data that unsupervised learning can train artificial intelligence that surpasses human beings in a certain field.

At present, the complete information game can be divided into two categories. The first category is the method based on an expert system, which is characterized by: (1) strong stability, in which the expert system executes everything according to procedures, unlike people who have various emotions; (2) fast speed, in which for tasks with strong repeatability or related intelligent algorithms, the response speed of the expert system is usually much faster than that of human beings; (3) strong adaptability, in which the expert system can adapt to various environments, including dangerous environments that human beings cannot adapt to; (4) strong flexibility, in which the expert system can conveniently add or delete functions and knowledge bases. Deep Blue, which once defeated chess masters, is based on the expert system. however, the expert system is constructed on human experience, which meant that the expert system is bound by the shackles of human experience and model construction. Therefore, it is always difficult for the expert system to defeat human chess players in Go, which has more decision-making space.

### SUMMARY

The present disclosure aims to overcome the shortcomings in the prior art and provide a chess self-learning method and device based on machine learning, which can self-generate chess game data and train according to the game data to improve the accuracy of the model.

In order to achieve the above purpose, the present disclosure is realized by using the following technical scheme.

In a first aspect, the present disclosure provides a chess self-learning method based on machine learning, comprising the following steps:

step A, constructing a neural network and randomly initializing parameters of the neural network;

step B, constructing a Monte Carlo tree, initializing nodes of the Monte Carlo tree using the neural network, self-playing by Monte Carlo tree search, generating game data, and storing the game data;

step C, training the neural network using the stored game data;

step D, repeating the processes from step B to step C until the neural network converges.

Further, the neural network comprises an input layer, a hidden layer and an output layer;

the input layer matches the size of the chess board to be trained;

the hidden layer uses the hidden layer structure of a convolutional neural network to complete the extraction and processing of position features;

the output layer comprises a game decision maker for outputting a move vector and a value evaluator of a value function for outputting the current position; and the game decision maker and the value evaluator of the value function share the same input layer and hidden layer.

Further, the method of constructing the neural network comprises:

setting the structure of the input layer and the decision output layer according to the size of the trained chess board, so that the sizes of the input layer and the decision output layer match the size of the chess board.

Further, the method of constructing a Monte Carlo tree, initializing nodes of the Monte Carlo tree using the neural network, self-playing by Monte Carlo tree search, and generating game data comprises:

constructing a Monte Carlo tree, in which each node Sₜ of the Monte Carlo tree contains the following attributes: 1, the array of a child node son[α]; 2, the array of the access number N[a]; 3, the array of the total value W[a]; 4, the average value Q[a]; 5, the array of the move probability P[a]; 6, the scalar NUM;

self-playing by Monte Carlo tree search, and controlling both players to conduct a round of Monte Carlo tree search based on the last move of the opponent as a root node, and after the Monte Carlo tree search is completed, obtaining the corresponding decision vector πₜ according to the selected proportion of each move α under the root node, and then selecting the move in the self-play according to πₜ;

after completing a game of self-play, attaching a value tag Z to each decision according to the ending outcome, that is, attaching a tag +1 to all decisions of the winner and a tag −1 to all decisions of the loser, generating a target pair, and storing the target pair (πₜ, Z) in a container; when the container is full, discarding the target pair (πₜ, Z) first placed in the container.

Further, the method of training the neural network using the stored game data comprises:

randomly selecting the target pair (πₜ, Z) from the container to train the neural network, where the loss function of the neural network is as follows:

loss=(Z−vₜ)²−πₜ^{T}logpₜ+c∥θ∥²

in which the move vector pₜ=(pₜ⁰, pₜ², . . . , pₜ^{a}, . . . , pₜ^{T-1}) is a 1×T-dimensional vector, the value range of its component pₜ^{a} is [0,1] and the sum of all components is 1, that is Σₐ₌₀^{T-1}pₜ^{a}=1; the component pₜ^{a} represents the probability of selecting the move α in the chess board state Sₜ; the chess board state Sₜ is input into the neural network, and the move of the neural network selects the output of the output layer, that is, pₜ; the decision vector πₜ=(πₜ⁰, πₜ², . . . , πₜ^{a}, . . . , πₜ^{T-1}) is a 1×T-dimensional vector, the value range of its component πₜ^{a} is [0,1] and the sum of all components is 1, that is Σₐ₌₀^{T-1}πₜ^{a}=1; the scalar value vₜ has a value range of [−1,1], which indicates the possibility that the mover wins in the current position, the larger value vₜ indicates that the current player wins more likely, and the smaller value vₜ indicates that the current player loses more likely; the chess board state Sₜ is input into the neural network, the value of the neural network evaluates the output of the output layer, that is, vₜ, and the game result is Z, which has the value of {−1,1}; Z=1 indicates that the current player wins in this game, and Z=−1 indicates that the current player loses in this game; c is a stable constant, θ=(θ⁰, θ¹, θ², . . . )is a vector consisted of all parameters of the neural network, c∥θ∥² is a regular term, and logpₜ means taking the logarithm of each component of pₜ;

the training target enabling the move vector pₜ output by the neural network to be close to the decision vector πₜ, so that the value judgment vₜ solves the final game result Z, that is, the loss function loss decreases as much as possible.

Further, the method of the Monte Carlo tree search comprises: selecting according to the following formula:

$${a}_{t} = {arg max}_{a} ( Q [ a ] + {U}_{a}^{{s}_{t}} )$$

$${U}_{a}^{{s}_{t}} = {C}_{t} {p}_{t}^{a} \sqrt{N U M} / ( 1 + N [ a ] )$$

$${C}_{t} = log ( \frac{1 + N U M + {c}_{base}}{{c}_{base}} ) + {c}_{i n i t}$$

in which the scalar NUM represents the total number of times that the node Sₜ is accessed with an initial value of 1, and whenever the node Sₜ is accessed, the cumulative value is increased by one; NUM=ΣₐN[α]; cᵢₙᵢₜ and c_{base} are two constants; Cₜ represents the exploration rate, the larger value indicates that the current Monte Carlo tree search trends to explore, the smaller value indicates that the current Monte Carlo tree search trends to select the best move according to the existing result; the move vector pₜ=(pₜ⁰, pₜ², . . . , pₜ^{a}, . . . , pₜ^{T-1}) is a 1×T-dimensional vector; the average value Q[a] indicates the average value obtained by selecting the move α in the current state Sₜ; the array of the access number is N[a] with length T; every Monte Carlo tree search returns when encountering unexpanded nodes, and recursively updates each node to the root node.

Further, the method of obtaining the corresponding decision vector πₜ according to the selected proportion of each move α under the root node after the Monte Carlo tree search is completed comprises: calculating the decision vector πₜ according to the following formula:

$${π}_{t}^{a} = \frac{{N [ a ]}^{1 / τ}}{N U {M}^{1 / τ}}$$

where τ≤1 is the parameter that controls the degree of exploration, the larger value τ indicates that the current Monte Carlo tree trends to search, the smaller value τ indicates that the current Monte Carlo tree trends to select the best strategy; the decision vector πₜ=(πₜ⁰, πₜ², . . . ,πₜ^{a}, . . . , πₜ^{T-1}) is a 1×T-dimensional vector; the array of the access number is N[a] with length T; and the scalar NUM represents the total number of times that the node Sₜ is accessed.

In a second aspect, the present disclosure provides a chess self-learning device based on machine learning, wherein the device comprises:

a network constructing module, which is configured to construct a neural network and randomly initialize parameters of the neural network;

a data generating module, which is configured to construct a Monte Carlo tree, initialize nodes of the Monte Carlo tree using the neural network, self-play by Monte Carlo tree search, generate game data, and store the game data;

a training module, which is configured to train the neural network using the stored game data;

a converging module, which is configured to control the data generating module to stop generating game data and control the converging module to stop training when the neural network converges.

In a third aspect, the present disclosure provides a chess self-learning device based on machine learning, comprising a processor and a storage medium;

wherein the storage medium is configured to store instructions;

the processor is configured to operate according to the instructions to execute the steps of the method according to the first aspect.

In a fourth aspect, the present disclosure provides a computer-readable storage medium on which a computer program is stored, wherein the program, when executed by a processor, implements the steps of the method according to the first aspect.

Compared with the prior art, the present disclosure has the following beneficial effects.

1. According to the method, the neural network is introduced to serve as a move selector and a value evaluator, the Monte Carlo tree serves as a strategy optimizer, self-play can be completed without chess knowledge of human beings, and finally training of the neural network is completed. The chess ability of an AI player can be improved for people to play chess.

2. Based on the move selector and the value evaluator of the present disclosure, the artificial intelligence of Gobang constructed by the present disclosure has higher chess ability and faster operation.

### BRIEF DESCRIPTION OF DRAWINGS

FIG. 1 is a schematic diagram of the overall structure of a high-resolution convolutional neural network according to the embodiment of the method of the present disclosure.

FIG. 2 is a training flow chart of the present disclosure.

FIG. 3 is a detailed schematic diagram of self-play in a first stage of the present disclosure.

FIG. 4 is a detailed schematic diagram of neural network training in a second stage of the present disclosure.

### DETAILED DESCRIPTION OF THE EMBODIMENTS

The present disclosure will be further described with reference to the accompanying drawings hereinafter. The following embodiments are only used to illustrate the technical scheme of the present disclosure more clearly, rather than limit the scope of protection of the present disclosure.

Embodiment 1:

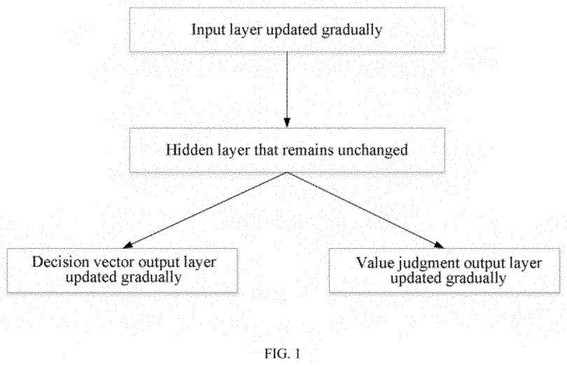

FIG. 1 is a flow chart of a deep reinforcement learning training method based on progressive transfer learning according to the present disclosure. Taking Gobang as an example, a Gobang self-learning method based on machine learning is provided, which comprises the following steps.

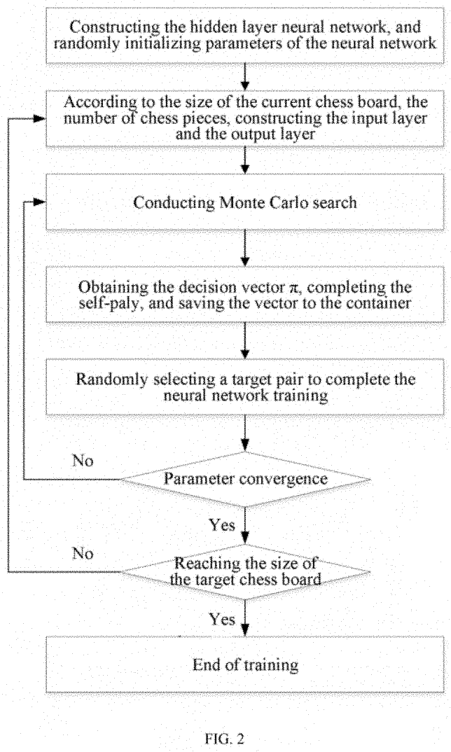

Step 1: A convolution neural network of depth residuals is constructed, and parameters of the neural network are randomly initialized. The neural network is divided into an input layer, a hidden layer and an output layer, as shown in FIG. 2. The input layer should match the size of the current chess board. The hidden layer has 3 layers of full convolution network, which use 32, 64 and 128 3×3 filters, respectively, and use ReLu activation function. The output layer is generally divided into two parts. One part is the game decision maker for outputting the move vector, the move vector is denoted as pₜ, the size of pₜ is 1×n, and the sum of all components of pₜ is 1. The range of components pₜ is [0,1], which represents the probability of selecting each move in the state Sₜ. The other part is the value evaluator of the value function for outputting the current position, in which the output value is the scalar vₜ between [−1,1]. The larger value vₜ indicates that the current position is more favorable for us, and the smaller value vₜ indicates that the current situation is more favorable for the opponent. The output layers of the two parts share the same input layer and hidden layer.

Step 2: The structures of the input layer and the decision output layer are set according to the size of the current Gobang chess board to be trained, so that the sizes of the input layer and the decision output layer match the size of the current chess board.

Step 3: A Monte Carlo tree is constructed, in which each node Sₜ of the Monte Carlo tree contains the following attributes: 1, the array of a child node son[α]; 2, the array of the access number N[a]; 3, the array of the total value W[a]; 4, the average value Q[a]; 5, the array of the move probability P[a]; 6, the scalar NUM;

Step 4: The move in Monte Carlo tree search is selected based on the maximum confidence formula (1):

$${a}_{t} = {arg max}_{{a}_{t}} ( Q [ a ] + {U}_{a}^{{s}_{t}} ) \qquad ( 1 )$$

$${U}_{a}^{{s}_{t}} = {C}_{t} {p}_{t}^{a} \sqrt{NUM} / ( 1 + N [ a ] ) \qquad ( 2 )$$

$${C}_{t} = log ( \frac{1 ⋆ NUM + {c}_{base}}{{c}_{base}} ) + {c}_{i n i t} \qquad ( 3 )$$

in which the scalar NUM represents the total number of times that the node Sₜ is accessed with an initial value of 1, and whenever the node Sₜ is accessed, NUM=NUM+1; NUM=ΣₐN[α]; cᵢₙᵢₜ and c_{base} are two constants; the move vector pₜ=(pₜ⁰, pₜ², . . . , pₜ^{a}, . . . , pₜ^{T-1}) is a 1×T-dimensional vector, the value range of its component pₜ^{a} is [0,1] and the sum of all components is 1, that is Σₐ₌₀^{T-1}pₜ^{a}=1. The component pₜ^{a} represents the probability of selecting the move α in the chess board state Sₜ. The chess board state Sₜ is input into the neural network, and the move of the neural network selects the output of the output layer, that is, pₜ. The array of the access number is N[a] with length T. The times of selecting move α in the current state Sₜ is recorded, the initial value of the array component is 0, and whenever move α is selected by Monte Carlo tree search, N[a]++. The move position is a=iM+j, the value range is an integer between {0, 1, 2, . . . , T−1 }, which corresponds to the coordinates (i, j) on the chess board, and αₜ represents the move selected by step t.

Cₜ represents the exploration rate, the larger value indicates that the current Monte Carlo tree search trends to explore, the smaller value indicates that the current Monte Carlo tree search trends to select the best move according to the existing result.

The value C(Sₜ) increases slowly with the search. Because Gobang is relatively simple, and the number of Monte Carlo tree searches is not large every time, C(Sₜ) degenerates into a constant C. The experiment shows that the value C is 5 with a better effect. Each round of Monte Carlo tree search is performed about 800 times. Each search returns when encountering an unexpanded node, and recursively updates each node to the root node.

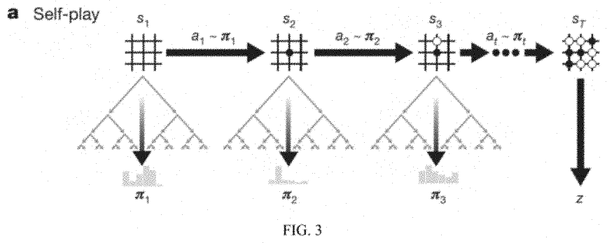

Step 5: After the Monte Carlo tree search is completed, the corresponding decision vector πₜ is obtained according to the selected proportion of each move α under the root node, and then the move in the self-play is selected according to πₜ, as shown in FIG. 3.

$${π}_{t}^{a} = \frac{{N [ a ]}^{1 / τ}}{{NUM}^{1 / τ}} \qquad ( 4 )$$

where τ≤1 is the parameter that controls the degree of exploration, the larger value τ indicates that the current Monte Carlo tree trends to search, and the smaller value τ indicates that the current Monte Carlo tree trends to select the best strategy. Generally speaking, it is assumed that τ value gradually decrease with the progress of the game, that is, the move in the early stage of the game tends to explore, and the move in the later stage of the game tends to select the optimal solution. Generally, let τ=1 in the first ten steps of the game, and τ=0.96 ^{t} in the later stage, where t is the number of steps of the game.

Step 6: After completing a game of self-play, a value tag Z is attached to each decision according to the ending outcome, that is, a tag+1 is attached to all decisions of the winner and a tag −1 is attached to all decisions of the loser, the target pair (πₜ, Z) is stored in a container, and when the container is full, the target pair (πₜ, Z) first placed in the container is discarded.

Step 7: The target pair (πₜ, Z) is randomly selected from the container to train the neural network, where the loss function of the neural network is shown in formula (5):

loss=(Z−vₜ)²−πₜ^{T}logpₜ+c∥θ∥² (5)

in which the move vector pₜ=(pₜ⁰, pₜ², . . . , pₜ^{a}, . . . , pₜ^{T-1}) is a 1×T-dimensional vector, the value range of its component pₜ^{a} is [0,1] and the sum of all components is 1, that is Σₐ₌₀^{T-1}pₜ^{a}=1. The component pₜ^{a} represents the probability of selecting the move α in the chess board state Sₜ; the chess board state Sₜ is input into the neural network, and the move of the neural network selects the output of the output layer, that is, pₜ; the decision vector πₜ=(πₜ⁰, πₜ², . . . ,πₜ^{a}, . . . , πₜ^{T-1} is a 1×T-dimensional vector, the value range of its component πₜ^{a} is [0,1] and the sum of all components is 1, that is Σₐ₌₀^{T-1}πₜ^{a}=1. The component πₜ^{a} represents the probability of selecting the move α in the chess board state Sₜ. πₜ indicates that the form and meaning are exactly the same as those of pₜ, except that pₜ is obtained by the neural network, while πₜ is obtained by Monte Carlo tree search. The scalar value vₜ has a value range of [−1,1], which indicates the possibility that the mover wins in the current position. The larger value vₜ indicates that the current player wins more likely, and the smaller value vₜ indicates that the current player loses more likely. The chess board state Sₜ is input into the neural network, the value of the neural network evaluates the output of the output layer, that is, vₜ, and the game result is Z, which has the value of {−1,1}. Z=1 indicates that the current player wins in this game, and Z=−1 indicates that the current player loses in this game. c is a stable constant, and θ=(θ⁰, θ¹, θ², . . . ) is a vector consisted of all parameters of the neural network. c∥θ∥² is a regular term, and logpₜ means taking the logarithm of each component of pₜ.

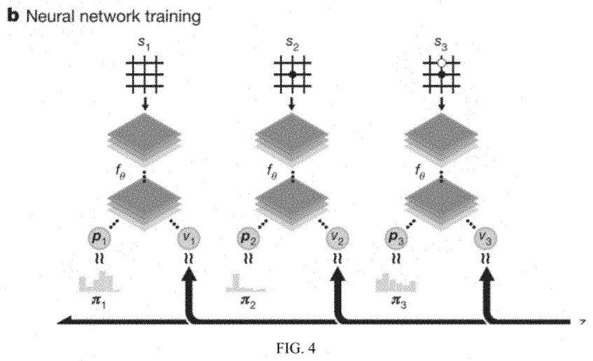

The training target enables the move vector pₜ output by the neural network to be close to the decision vector πₜ, so that the value judgment vₜ solves the final game result Z, that is, the loss function loss decreases as much as possible. The specific training step comprises: denoting

$${θ}^{i} = {θ}^{i - 1} - {l}_{r} \frac{\partial loss}{\partial θ} ,$$

where lᵣ is the extent of the influence of the learning rate on the change of the parameter θ of each target pair, which is generally 0.01. Each target pair is brought into the above formula to update the parameter θ until loss decreases slowly or decreases no longer, as shown in FIG. 4.

Step 8: Repeat steps 2 to 6 to finish the training of the parameters of the Gobang chess board which are gradually increasing, and the same hidden layer parameters are kept so as to finish the training of the parameters of the hidden layer of the big chess board until the training is finished.

According to the method, the neural network is introduced to serve as a move selector and a value evaluator, the Monte Carlo tree serves as a strategy optimizer, self-play can be completed without Gobang knowledge of human beings, and finally training of the neural network is completed. The present disclosure aims to construct an AI chess player of Gobang for people to play chess. The neural network is introduced to serve as a move selector and a value evaluator, the Monte Carlo tree serves as a strategy optimizer, self-play can be completed without Gobang knowledge of human beings, and finally training of the neural network is completed. The chess ability of an AI player can be improved for people to play chess. Based on the move selector and the value evaluator of the present disclosure, the artificial intelligence of Gobang constructed by the present disclosure has higher chess ability and faster operation.

In this embodiment, each symbol is defined as follows.

It is assumed that the size of the chess board is T=N×M (usually square, that is, N=M), where N represents the total number of rows (horizontal lines) and M represents the total number of columns (vertical lines). The value ranges of the integer variables i and j are {0, 1, 2, . . . , N−1} and {0, 1, 2, . . . , M−1}, respectively, and then:

the move position is a=iM+j, the value range is an integer between {0, 1, 2, . . . , T−1 }, which corresponds to the coordinates (i, j) on the chess board, and αₜ represents the move selected by step t.

The number t of moves on the chess board is denoted as the number of steps of the game, and the value range is {0, 1, 2, . . . , T}.

3. The chess board state Sₜ=(sₜ⁰, sₜ¹, . . . , sₜ^{a}, . . . , sₜ^{T-1}) is a 1×T-dimensional vector, and the value of its components sₜ^{a} is {−1, 0, 1}, which indicates that a black piece moves, there is no move, and a white piece moves, respectively. For example, sₜ^{a}=1 indicates that a white piece moves in the position (i, j) of the chess board when the game is subjected to t steps.

4. The whole game process is represented by the set S={s0, s1, s2, . . . , st, . . . }, which corresponds to the chess board state with different numbers of moves, respectively.

5. The value scalar vₜ has a value range of [−1,1], which indicates the possibility that the mover wins in the current position, the larger value vₜ indicates that the current player wins more likely, and the smaller value vₜ indicates that the current player loses more likely. The chess board state Sₜ is input into the neural network, and the value of the neural network evaluates the output of the output layer, that is, vₜ.

6. The move vector pₜ=(pₜ⁰, pₜ², . . . , pₜ^{a}, . . ., pₜ^{T-1}) is a 1×T-dimensional vector, the value range of its component pₜ^{a} is [0,1] and the sum of all components is 1, that is Σₐ₌₀^{T-1}pₜ^{a}=1. The component pₜ^{a} represents the probability of selecting the move α in the chess board state Sₜ. The chess board state Sₜ is input into the neural network, and the move of the neural network selects the output of the output layer, that is pₜ.

7. The decision vector πₜ=(πₜ⁰, πₜ², . . . , πₜ^{a}, . . . , πₜ^{T-1}) is a 1×T-dimensional vector, the value range of its component πₜ^{a}is [0,1] and the sum of all components is 1, that is Σ_{α=0}^{T-1}πₜ^{a}=1. The component πₜ^{a} represents the probability of selecting the move α in the chess board state Sₜ. πₜ indicates that the form and meaning are exactly the same as those of pₜ, except that pₜ is obtained by the neural network, while πₜ is obtained by Monte Carlo tree search.

8. The game result is Z, which has the value of {−1,1}. Z=1 indicates that the current player wins in this game, and Z=−1 indicates that the current player loses in this game.

9. The array of a child node is son[α] with length T, which is used to store the pointer to the child node sₜ₊₁. For example, son[0] represents the pointer of the child node after the current node moves at 0.

10. The array of the access number is N[a] with length T. The times of selecting move α in the current state Sₜ is recorded, the initial value of the array component is 0, and whenever move α is selected by Monte Carlo tree search, N[a]++.

11. The array of the total value is W[a] with length T. The total value of selecting move α in the current state sₜ is recorded, the initial value of the array component is 0, and whenever move α is selected by Monte Carlo tree search, W[a]+=vₜ.

12. The average value Q[a] indicates the average value obtained by selecting move α in the current state Sₜ, Q[a]=W[a]/N[a].

13. The array of the move probability P[a] records the probability of selecting move α in the current state Sₜ. The initial value is pₜ, which is obtained from the output of the latest neural network. Each node is initialized only once and will not be updated.

14. The scalar NUM represents the total number of times that the node Sₜ is accessed with an initial value of 1, and whenever the node Sₜ is accessed, NUM=NUM+1. Moreover, NUM =ΣₐN[α].

15. θ=(θ⁰, θ¹, θ², . . . ) is a vector consisted of all the parameters of the neural network.

Embodiment 2:

A chess self-learning device based on machine learning is provided, wherein the device comprises:

a network constructing module, which is configured to construct a neural network and randomly initialize parameters of the neural network;

a data generating module, which is configured to construct a Monte Carlo tree, initialize nodes of the Monte Carlo tree using the neural network, self-play by Monte Carlo tree search, generate game data, and store the game data;

a training module, which is configured to train the neural network using the stored game data;

a converging module, which is configured to control the data generating module to stop generating game data and control the converging module to stop training when the neural network converges.

Embodiment 3:

The embodiment of the present disclosure further provides a chess self-learning device based on machine learning, comprising a processor and a storage medium;

wherein the storage medium is configured to store instructions;

the processor is configured to operate according to the instructions to execute the steps of the method according to Embodiment 1.

Embodiment 4:

The embodiment of the present disclosure further provides a computer-readable storage medium on which a computer program is stored, wherein the program, when executed by a processor, implements the steps of the method according to Embodiment 1.

It should be understood by those skilled in the art that the embodiments of the present disclosure can be provided as methods, systems, or computer program products. Therefore, the present disclosure can take the form of an entirely hardware embodiment, an entirely software embodiment, or an embodiment combining software and hardware aspects. Furthermore, the present disclosure may take the form of a computer program product implemented on one or more computer usable storage media (including but not limited to a disk storage, CD-ROM, an optical storage, etc.) in which computer usable program codes are contained.

The present disclosure is described with reference to flow charts and/or block diagrams of methods, devices (systems), and computer program products according to embodiments of the present disclosure. It should be understood that each flow and/or block in flow charts and/or block diagrams and combinations of flows and/or blocks in flow charts and/or block diagrams can be realized by computer program instructions. These computer program instructions may be provided to the processor of a general-purpose computer, a special-purpose computer, an embedded processor or other programmable data processing devices to produce a machine, so that the instructions executed by the processor of the computer or other programmable data processing devices produce means for implementing the functions specified in one or more flows of flow charts and/or one or more blocks of block diagrams.

These computer program instructions can also be stored in a computer-readable memory that can direct a computer or other programmable data processing devices to work in a specific way, so that the instructions stored in the computer-readable memory produce an article of manufacture including instruction means that implement the functions in one or more flows of flow charts and/or one or more blocks of block diagrams.

These computer program instructions can also be loaded on a computer or other programmable data processing devices, so that a series of operation steps are executed on the computer or other programmable devices to produce a computer-implemented process. Therefore, the instructions executed on the computer or other programmable devices provide steps for implementing the functions in one or more flows of flow charts and/or one or more blocks of block diagrams.

The above are only the preferred embodiments of the present disclosure. It should be pointed out that those skilled in the art can make several improvements and variations without departing from the technical principle of the present disclosure, which should also be regarded as the scope of protection of the present disclosure.

What is claimed is:

1. A chess self-learning method based on machine learning, comprising the following steps:
step A, constructing a neural network and randomly initializing parameters of the neural network;
step B, constructing a Monte Carlo tree, initializing nodes of the Monte Carlo tree using the neural network, self-playing by Monte Carlo tree search, generating game data, and storing the game data;
step C, training the neural network using the stored game data;
step D, repeating the processes from step B to step C until the neural network converges.

2. The chess self-learning method based on machine learning according to claim 1, wherein the neural network comprises an input layer, a hidden layer and an output layer;
the input layer matches the size of the chess board to be trained;
the hidden layer is used to complete the extraction and processing of position features;
the output layer comprises a game decision maker for outputting a move vector and a value evaluator of a value function for outputting the current position; and the game decision maker and the value evaluator of the value function share the same input layer and hidden layer.

3. The chess self-learning method based on machine learning according to claim 2, wherein the method of constructing the neural network comprises:
setting the structure of the input layer and the decision output layer according to the size of the trained chess board, so that the sizes of the input layer and the decision output layer match the size of the chess board.

4. The chess self-learning method based on machine learning according to claim 1, wherein the method of constructing a Monte Carlo tree, initializing nodes of the Monte Carlo tree using the neural network, self-playing by Monte Carlo tree search, and generating game data comprises:
constructing a Monte Carlo tree;
self-playing by Monte Carlo tree search, and controlling both players to conduct a round of Monte Carlo tree search based on the last move of the opponent as a root node;
after the Monte Carlo tree search is completed, obtaining the corresponding decision vector πₜ according to the selected proportion of each move α under the root node, and then selecting the move in the self-play according to πₜ;
after completing a game of self-play, attaching a value tag Z to each decision according to the ending outcome, that is, attaching a tag +1 to all decisions of the winner and a tag −1 to all decisions of the loser, generating a target pair (πₜ, Z), and storing the target pair (πₜ, Z) in a container; when the container is full, discarding the target pair first placed in the container.

5. The chess self-learning method based on machine learning according to claim 4, wherein the method of training the neural network using the stored game data comprises:
randomly selecting the target pair (πₜ, Z) from the container to train the neural network, where the loss function of the neural network is as follows:
loss=(Z−vₜ)²−πₜ^{T}logpₜ+c∥θ∥²
in which the move vector pₜ=(pₜ⁰, pₜ², . . . , pₜ^{a}, . . . , pₜ^{T-1}) is a 1×T-dimensional vector, the decision vector πₜ=(πₜ⁰, πₜ², . . . , πₜ^{a}, . . . , πₜ^{T-1}) is a 1×T-dimensional vector, the scalar value Vₜ has a value range [−1,1] , which indicates the possibility that the mover wins in the current position, the larger value Vₜ indicates that the current player wins more likely, and the smaller value Vₜ indicates that the current player loses more likely; c is a stable constant, θ=(θ⁰, θ¹, θ², . . . ) is a vector consisted of all parameters of the neural network, c∥θ∥² is a regular term, and logpₜ means taking the logarithm of each component of pₜ;
enabling the move vector pₜ output by the neural network to be close to the decision vector πₜ, so that the value judgment Vₜ solves the final game result Z, that is, the loss function loss decreases as much as possible.

6. The chess self-learning method based on machine learning according to claim 4, wherein the method of the Monte Carlo tree search comprises: selecting according to the following formula:
$${a}_{t} = {arg max}_{a} ( Q [ a ] + {U}_{a}^{{s}_{t}} )$$
$${U}_{a}^{{s}_{τ}} = {C}_{t} {p}_{t}^{a} \sqrt{NUM} / ( 1 + N [ a ] )$$
$${C}_{t} = log ( \frac{1 + N U M + {c}_{base}}{{c}_{base}} ) + {c}_{init}$$
in which the scalar NUM represents the total number of times that the node Sₜ is accessed; cᵢₙᵢₜ and c_{base} are two constants; Cₜ represents the exploration rate, the larger value indicates that the current Monte Carlo tree search trends to explore, the smaller value indicates that the current Monte Carlo tree search trends to select the best move according to the existing result; the move vector pₜ=(pₜ⁰, pₜ², . . . , pₜ^{a}, . . . , pₜ^{T-1}) is a 1×T-dimensional vector; the average value Q[a] indicates the average value obtained by selecting the move α in the current state Sₜ; the array of the access number is N[a] with length T;
every Monte Carlo tree search returns when encountering unexpanded nodes, and recursively updates each node to the root node.

7. The chess self-learning method based on machine learning according to claim 4, wherein the method of obtaining the corresponding decision vector RI according to the selected proportion of each move α under the root node after the Monte Carlo tree search is completed comprises: calculating the decision vector it according to the following formula:
$${π}_{t}^{a} = \frac{{N [ a ]}^{1 / τ}}{{NUM}^{1 / τ}}$$
where τ≤1 is the parameter that controls the degree of exploration, the larger value τ indicates that the current Monte Carlo tree trends to search, the smaller value τ indicates that the current Monte Carlo tree trends to select the best strategy; the decision vector πₜ=(πₜ⁰, πₜ², . . . , πₜ^{a}, . . . , πₜ^{T-1}) is a 1×T-dimensional vector;
the array of the access number is N[a] with length T; and the scalar NUM represents the total number of times that the node Sₜ is accessed.

8. A chess self-learning device based on machine learning, wherein the device comprises:
a network constructing module, which is configured to construct a neural network and randomly initialize parameters of the neural network;
a data generating module, which is configured to construct a Monte Carlo tree, initialize nodes of the Monte Carlo tree using the neural network, self-play by Monte Carlo tree search, generate game data, and store the game data;
a training module, which is configured to train the neural network using the stored game data;
a converging module, which is configured to control the data generating module to stop generating game data and control the converging module to stop training when the neural network converges.

9. A chess self-learning device based on machine learning, comprising a processor and a storage medium;
wherein the storage medium is configured to store instructions;
the processor is configured to operate according to the instructions to execute the steps of the method according to claim 1.

10. A computer-readable storage medium on which a computer program is stored, wherein the program, when executed by a processor, implements the steps of the method according to claim 1.
